(19) United States
(12) Patent Application Publication
(10) Pub. No.: US 2005/0104560 A1
(43) Pub. Date: May 19, 2005

(54) Voltage sense apparatus and method for a capacitor charger

(76) Inventor: Chung-Lung Pai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/988,759

(22) Filed: Nov. 16, 2004

(30) Foreign Application Priority Data
Nov. 19, 2003 (TW) 092132452

(51) Int. Cl. H02J 7/00

(52) U.S. Cl. 320/166

(57) ABSTRACT

In a capacitor charger including a transformer to transform a primary coil voltage to a secondary coil voltage to charge through a charging node a capacitor that is connected to an output to approach a predetermined voltage thereon, a voltage sense apparatus and method comprise sensing the voltage on the capacitor with a voltage divider or a sense current flowing through a resistor to generate a feedback signal to stop charging the capacitor when the capacitor voltage is sensed to be equal to or higher than the predetermined voltage, and applying prevention of an inverse current flowing from the capacitor to the charging node for the capacitor from leakage through the voltage sense apparatus.

### FIELD OF THE INVENTION

The present invention is related generally to a capacitor charger and more particularly, to a voltage sense apparatus and method for a capacitor charger.

### BACKGROUND OF THE INVENTION

Capacitor charger receives more and more attentions due to the gradually popular portable apparatus. A typical application of capacitor charger is for the power supply of flash lamp. Conventionally, as shown in FIG. 1, a capacitor charger 100 for a flash lamp has a transformer 102 including a primary coil L1 and a secondary coil L2 with turns ratio of N_{P}:N_{S}, to transform the primary coil voltage V_{bat} to a secondary coil voltage V_{S}, to charge a capacitor C_{O} through a diode 104, to supply the electric power for a flash lamp module 106 connected to an output Vout. An integrated circuit 108 switches the transistor M1 connected between the coil L1 and ground GND by the driver 112 controlled by the control circuit 110 to control the power delivery of the transformer 102. To sense the capacitor voltage Vout, resistors R1 and R2 are connected between the output Vout and ground GND to divide the voltage Vout to generate a feedback signal V_{FB} to the integrated circuit 108 that has a comparator 114 to compare the feedback signal V_{FB} with a reference Vref to generate a comparison signal S for the control circuit 110. Subsequently, the charger 100 will stop charging the capacitor C_{O} when the capacitor voltage Vout reaches the predetermined level.

For the power delivery, the operations of the charger 100 shown in FIG. 1 are illustrated by FIG. 2 and FIG. 3. When the transistor M1 conducts a current I1, as shown in FIG. 2, the voltage V_{S} and the current I2 both are zero. When the transistor M1 is turned off, the capacitor C_{O} is charged by the current I2, as shown in FIG. 3. Once the capacitor voltage Vout reaches or exceeds the predetermined level, the feedback signal V_{FB} is equal to or larger than the reference Vref, and the output S of the comparator 116 signals the control circuit 110 to stop charging the capacitor C_{O}. However, since the resistors R1 and R2 are connected between the output Vout and ground GND, there is always a leakage path, as shown in FIG. 4, by which a leakage current I_{Loss} flows from the capacitor C_{O} to ground GND through the resistors R1 and R2, resulting in voltage drop of the capacitor voltage Vout and power loss from the capacitor C_{O}.

To reduce such power loss, Schenkel et al. proposed a capacitor charger circuit in U.S. Pat. No. 6,518,733, by sensing the primary coil voltage to determine to stop charging the capacitor. Even this art removes the mentioned power loss from the voltage sense apparatus, it also has the whole circuit to be complicated and huge.

Therefore, it is desired a simple and lossless capacitor charge sensing apparatus and method for capacitor charger.

### SUMMARY OF THE INVENTION

One object of the present invention is to provide a voltage sense apparatus and method for a capacitor charger, which can prevent the charged capacitor from leakage through the voltage sense apparatus.

In a capacitor charger including a transformer to transform a primary coil voltage to a secondary coil voltage to charge through a charging node a capacitor that is connected to an output to approach a predetermined voltage thereon, according to the present invention, a voltage sense apparatus and method comprise sensing the voltage on the capacitor with a voltage divider to generate a feedback signal for the capacitor charger to stop charging the capacitor when the capacitor voltage is sensed to be equal to or higher than the predetermined voltage, and preventing an inverse current flowing from the capacitor to the charging node by a rectifier circuit. As a result, the capacitor is prevented from current leakage and power loss through the voltage sense apparatus.

Alternatively, according to the present invention, a voltage sense apparatus and method comprise sensing the voltage on the capacitor to generate a sense current to flow through a resistor to generate the feedback signal for the capacitor charger, and preventing an inverse current flowing from the capacitor to the charging node by a rectifier circuit to prevent the capacitor from current leakage and power loss through the voltage sense apparatus.

In another embodiment, according to the present invention, a voltage sense apparatus and method comprise transforming the primary coil voltage to a second secondary coil voltage, generating the feedback signal for the capacitor charger by dividing the second secondary coil voltage or by generating a sense current from the second secondary coil voltage to flow through a resistor, and preventing an inverse current flowing from the capacitor to the charging node by a rectifier circuit.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows the circuit diagram of a conventional capacitor charger for a flash lamp;

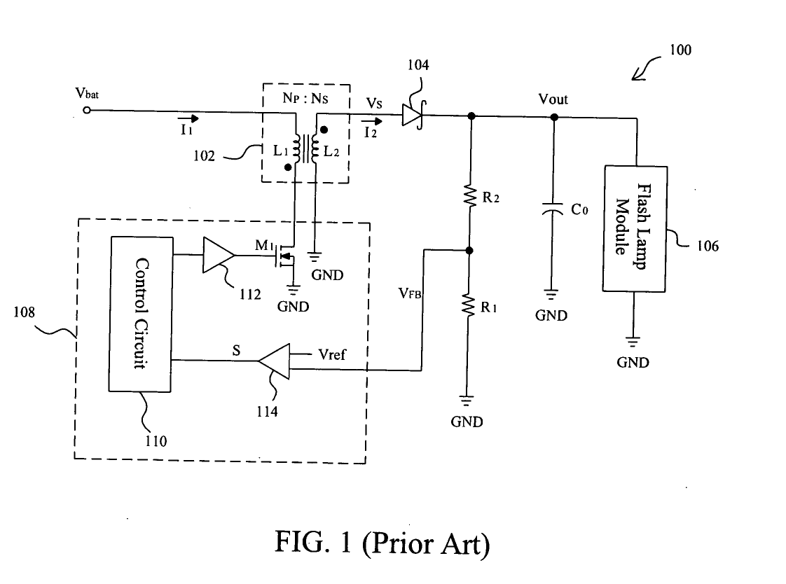

FIG. 2 illustrates the status when the transistor M1 in the charger shown in FIG. 1 is conducted;

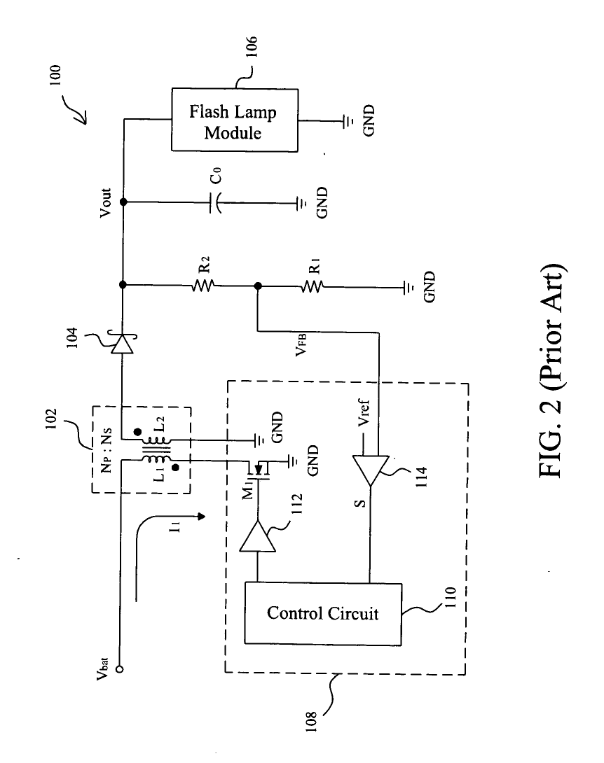

FIG. 3 illustrates the status when the transistor M1 in the charger shown in FIG. 1 is turned off;

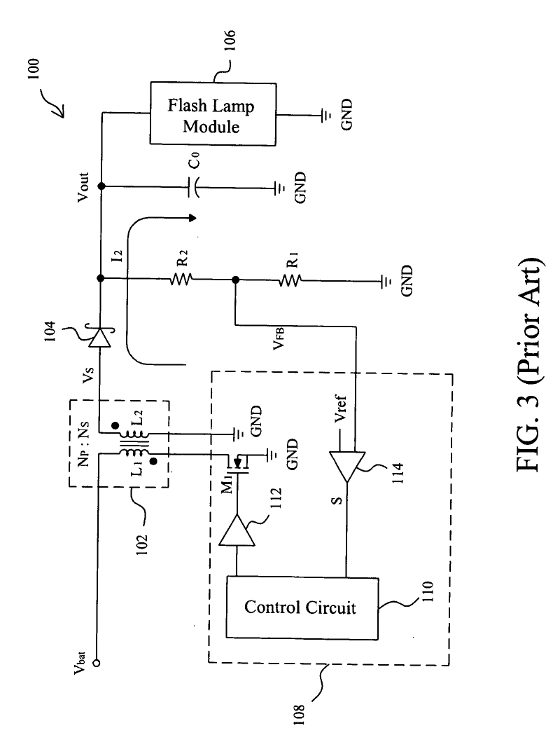

FIG. 4 illustrates the leakage occurred in the charger shown in FIG. 1;

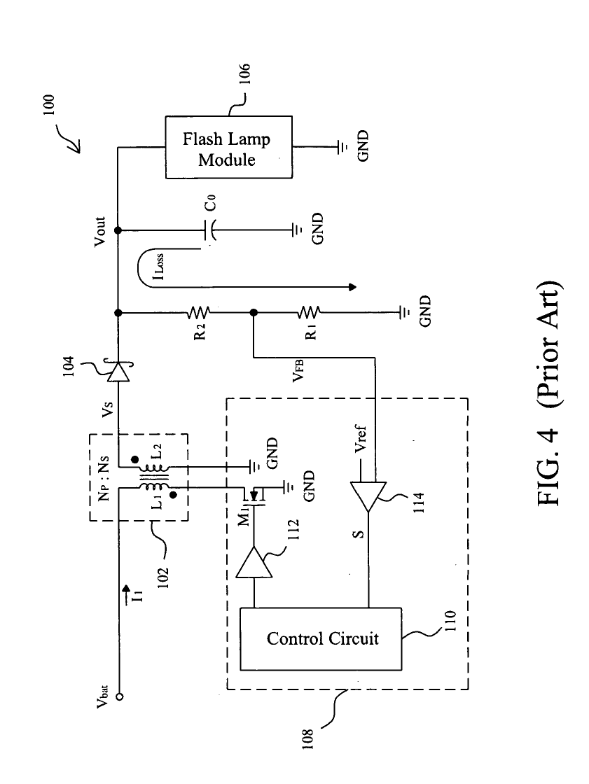

FIG. 5 shows the first embodiment of the present invention;

FIG. 6 shows the second embodiment of the present invention;

FIG. 7 shows the third embodiment of the present invention;

FIG. 8 shows the fourth embodiment of the present invention;

FIG. 9 shows the fifth embodiment of the present invention;

FIG. 10 shows the sixth embodiment of the present invention;

FIG. 11 shows the seventh embodiment of the present invention; and

FIG. 12 shows the eighth embodiment of the present invention.

### DETAILED DESCRIPTION OF THE INVENTION

The present invention will be illustrated by various embodiments which either employ voltage divider to sense the capacitor voltage and to generate a feedback signal by a feedback apparatus in the voltage divider, or a sense current to flow through a resistor to generate a feedback signal, for a capacitor charger to stop charging the capacitor when the capacitor voltage reaches a predetermined value. However, the detailed circuits in these embodiments are designed to illustrate the present invention, but not desired to be limitations to the present invention.

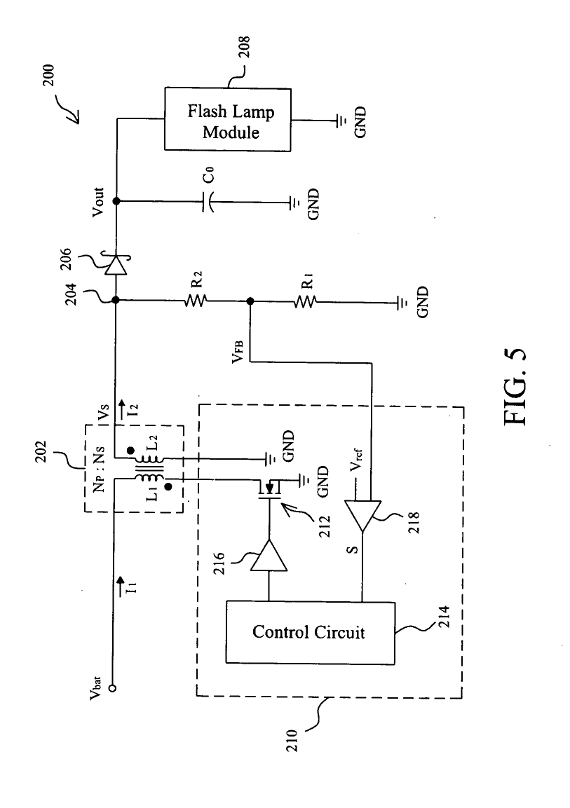

FIG. 5 shows the first embodiment of the present invention. In a capacitor charger 200, a transformer 202 has a primary coil L1 and a secondary coil L2 with a turns ratio of N_{P}:N_{S} to transform the primary coil voltage V_{bat} to a secondary coil voltage V_{S}, through a charging node 204 to charge a capacitor C_{O} connected to an output Vout to supply a flash lamp module 208, an integrated circuit 210 switches a transistor 212 connected between the coil L1 and ground GND by a driver 216 through a control circuit 214 to control the power delivery of the transformer 202. To sense the capacitor voltage Vout, resistors R1 and R2 are connected in series between the charging node 204 and ground GND to divide the charging voltage V_{S} on the charging node 204, to generate a feedback signal V_{FB} for the integrated circuit 210 that has a comparator 218 to compare the feedback signal V_{FB} with a reference Vref to generate a comparison signal S to signal the control circuit 214 to stop charging the capacitor C_{O} when the capacitor voltage Vout reaches a predetermined level. A diode 206 is further connected between the charging node 204 and output Vout to prevent an inverse current flowing from the output Vout to the charging node 204.

Still referring to FIG. 5, when the transistor 212 conducts a current I1, the secondary coil voltage V_{S} of the transformer 202 is

$${V}_{S} = ( - {V}_{bat} ) \times \frac{{N}_{S}}{{N}_{P}} . \qquad [ EQ \text{-} 1 ]$$

Due to the negative value of V_{S}, a current I2 flows from ground GND to the transformer 202 through the resistors R1 and R2, thereby generating the feedback signal by voltage dividing theory

$${V}_{FB} = {V}_{S} \times \frac{R1}{R1 + R2} = - {V}_{bat} \times \frac{{N}_{S}}{{N}_{P}} \times \frac{R1}{R1 + R2} , \qquad [ EQ \text{-} 2 ]$$

and therefore, the feedback signal V_{FB} also has a negative value. Latch-up is easily occurred to most integrated circuits formed on P-type substrates if the voltages on their pins are lower than −0.3V, and therefore, the turns ratio N_{P}:N_{S} of the coils L1 and L2 and the resistance ratio of the resistors R1 and R2 are preferably selected to have the feedback signal V_{FB} not lower than −0.3V. On the other hand, when the transistor 212 is turned off, the current I2 flows from the transformer 202 to the capacitor C_{O}, thereby charging the capacitor C_{O}, and the secondary coil voltage is
V_{S}=Vout+V_{f}, [EQ-3]
where V_{f} is the forward bias of the diode 206. Likewise, by the voltage dividing theory, the feedback signal is

$${V}_{FB} = ( Vout + {V}_{f} ) \times \frac{R1}{R1 + R2} . \qquad [ EQ \text{-} 4 ]$$

When the feedback signal V_{FB} is equal to or larger than the reference Vref, the output S of the comparator 218 will signal the control circuit 214 to stop charging-the capacitor C_{O}. The diode 206 prevents the capacitor C_{O} from the leakage through the resistors R1 and R2 to ground GND.

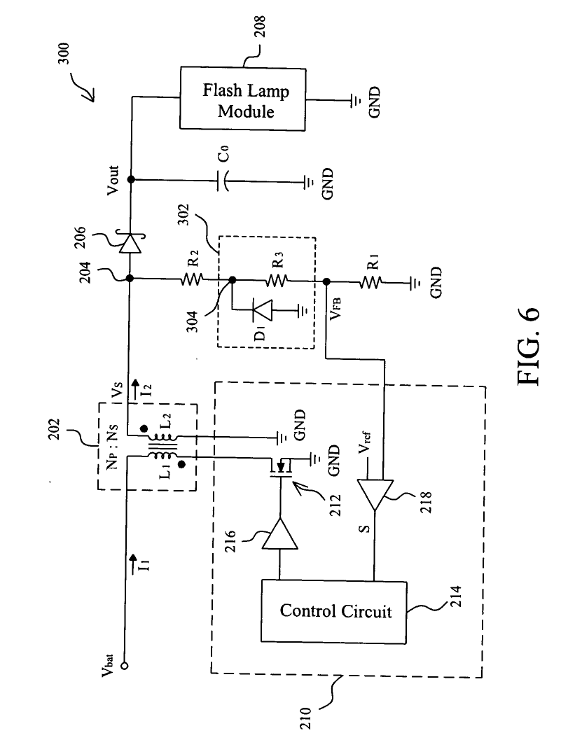

FIG. 6 shows the second embodiment of the present invention, which capacitor charger 300 is a modification of the charger 200 shown in FIG. 5 with a voltage clamping circuit 302 inserted between the resistors R1 and R2. In the voltage clamping circuit 302, a resistor R3 is connected between the resistors R1 and R2, and a diode D1 is connected between a clamping node 304 and ground GND. When the transistor 212 is turned on, due to the forward bias of the diode D1 of about 0.7V, the voltage on the clamping node 304 is clamped at −0.7V, and thus, according to voltage dividing theory, the feedback signal is

$${V}_{FB} = ( - 0.7 ) \times \frac{R1}{R1 + R3} . \qquad [ EQ \text{-} 5 ]$$

By selecting the resistances of the resistors R1 and R3, the feedback signal V_{FB} can be determined to be not lower than −0.3V. In further modified embodiments, the diode D1 can be replaced by several diodes connected in series, or the positive electrode of the diode D1 connected to ground GND in FIG. 6 can be alternatively connected to a reference voltage, thereby having the voltage on the clamping node 304 to be clamped over a desired level.

Still referring to FIG. 6, when the transistor 212 is turned off, the current I2 flows from the transformer 202 to the capacitor C_{O}, and thus charges the capacitor C_{O}. The secondary coil voltage V_{S} also follows the equation EQ-3, and according to voltage dividing theory, the feedback signal is

$${V}_{FB} = ( Vout + {V}_{f} ) \times \frac{R1}{R1 + R2 + R3} , \qquad [ EQ \text{-} 6 ]$$

where V_{f} is the forward bias of the diode 206. When the feedback signal V_{FB} is equal to or larger than the reference Vref, the output S of the comparator 218 will have the control circuit 214 to stop charging the capacitor C_{O}. Likewise, the diode 206 prevents the capacitor C_{O} from leakage through the resistors R1, R2 and R3 to ground GND.

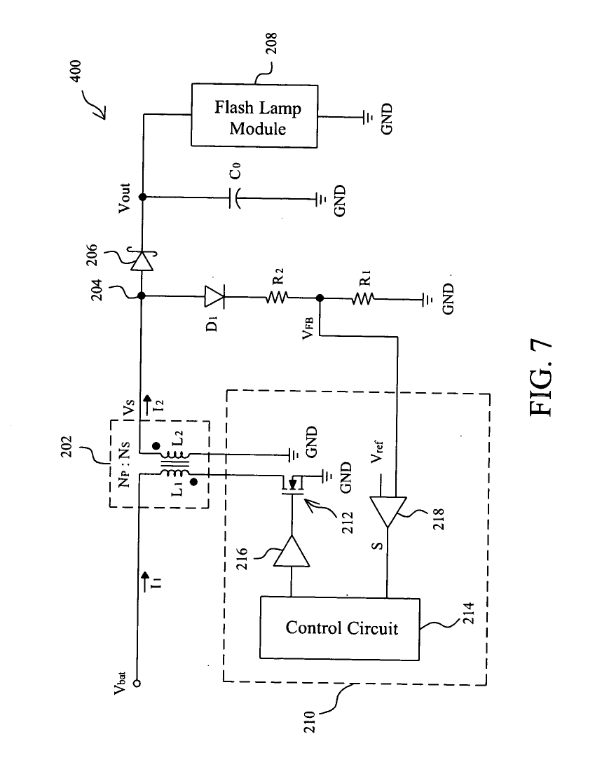

FIG. 7 shows the third embodiment of the present invention, which capacitor charger 400 is also a modification of the charger 200 shown in FIG. 5 with a diode D1 inserted between the charging node 204 and resistor R2. In the charger 400, the diode D1 prevents an inverse current flowing from ground GND to the charging node 204. However, apparently the location of these three elements D1, R1 and R2 are interchangeable, without departing from their operations. When the transistor 212 is turned on, the diode D1 blocks the path between the charging node 204 and ground GND, thereby no current flowing through the resistors R1 and R2, and the feedback signal V_{FB} is equal to zero. When the transistor 212 is turned off, the current I2 flows from the transformer 202 to the capacitor C_{O} to charge the capacitor C_{O}. The secondary coil voltage V_{S} still follows the equation EQ-3, and according to voltage dividing theory, the feedback signal is

$${V}_{FB} = ( Vout + {V}_{f} - {V}_{D1} ) \times \frac{R1}{R1 + R2} \qquad [ EQ \text{-} 7 ]$$

where V_{D}1 is the forward bias of the diode D1. When the feedback signal V_{FB} is equal to or larger than the reference Vref, the output S of the comparator 218 signals the control circuit 214 to stop charging the capacitor C_{O}. The diode 206 still prevents the capacitor C_{O} from leakage through the resistors R1 and R2 and diode D1 to ground GND.

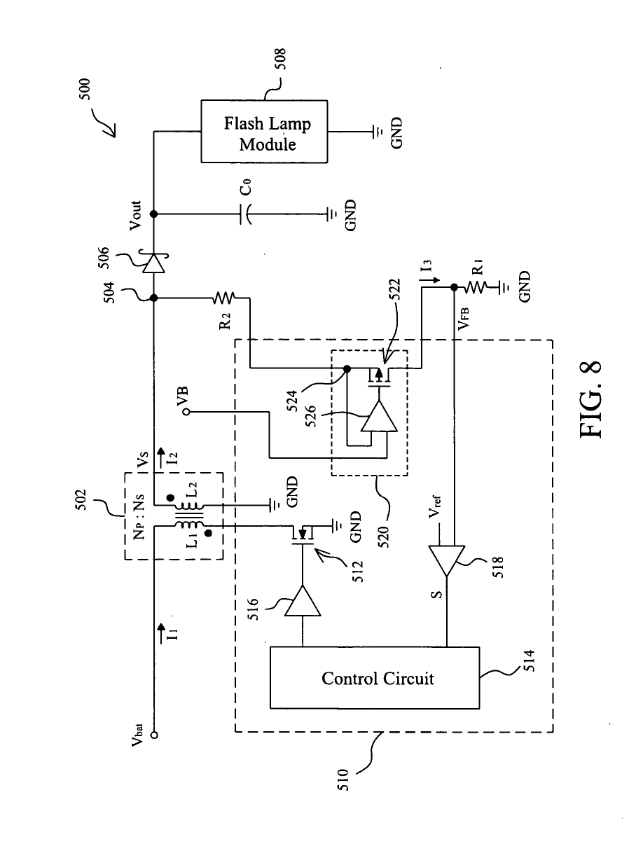

FIG. 8 shows the fourth embodiment of the present invention. In a capacitor charger 500, a transformer 502 has a primary coil L1 and a secondary coil L2 with a turns ratio of N_{P}:N_{S} to transform the primary coil voltage V_{bat} to a secondary coil voltage V_{S}, through a charging node 504 to charge a capacitor Co connected to an output Vout to supply a flash lamp module 508, an integrated circuit 510 switches a transistor 512 connected between the coil L1 and ground GND by a driver 516 through a control circuit 514 to control the power delivery of the transformer 502. To sense the capacitor voltage Vout, a servo amplifier 520 has an operational amplifier 526 with its two inputs connected to a reference voltage VB and a servo node 524, respectively, for the servo node 524 to be at the reference voltage VB, and a transistor 522 connected between the servo node 524 and a feedback node V_{FB} with its gate connected with the output of the operational amplifier 526, and a resistor R2 is connected between the charging node 504 and servo node 524, to generate a sense current I3 flowing therethrough and through the transistor 522 in the servo amplifier 520 to provide to the feedback node V_{FB} connected with a resistor R1. The sense current I3 is determined by the resistance of the resistor R2 and the voltage drop thereacross, i.e., the voltage difference between the nodes 504 and 524, and the feedback signal V_{FB} provided for the integrated circuit 510 is determined by the product of the resistance of the resistor R1 and the sense current I3. The comparator 518 in the integrated circuit 510 compares the feedback signal V_{FB} with a reference Vref to generate a comparison signal S for the control circuit 514 to stop charging the capacitor C_{O} when the capacitor voltage Vout reaches a predetermined value. To prevent an inverse current flowing from the output Vout to the charging node 504, a diode 506 is connected between the charging node 504 and output Vout.

Still referring to FIG. 8, when the transistor 512 conducts a current I1, the secondary coil voltage Vs of the transformer 502 is at a negative level, and the transistor 522 is thus turned off, and the feedback signal V_{FB} is equal to zero. When the transistor 512 is turned off, the current I2 charges the capacitor C_{O}, the servo voltage on the servo node 524 is VB, and the voltage V_{S} of the secondary coil follows the equation EQ-3. Through the resistor R2 the sense current is

$$I3 = \frac{Vs - VB}{R2} = \frac{Vout + {V}_{f} - VB}{R2} , \qquad [ EQ \text{-} 8 ]$$

and therefore the feedback signal is

$${V}_{FB} = \frac{R1 \times ( Vout + {V}_{f} - VB )}{R2} . \qquad [ EQ \text{-} 9 ]$$

Likewise, when the feedback signal V_{FB} is equal to or larger than the reference Vref, the output S of the comparator 518 has the control circuit 514 to stop charging the capacitor C_{O}. The diode 506 prevents the capacitor C_{O} from leakage through the resistors R1 and R2 and the transistor 522 to ground GND.

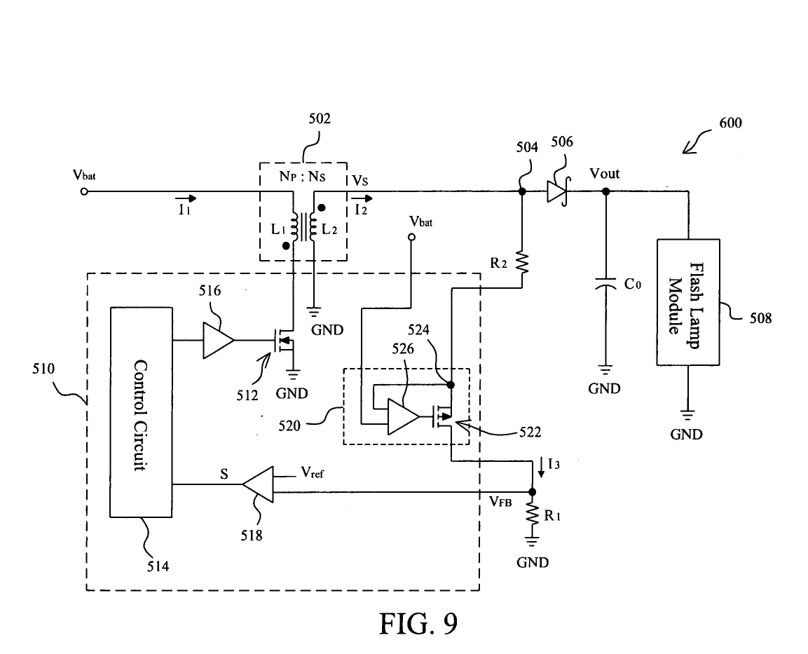

FIG. 9 shows the fifth embodiment of the present invention, which capacitor charger 600 is a modification of the charger 500 shown in FIG. 8 with the reference voltage VB for the servo amplifier 520 to be the primary coil voltage V_{bat}, which can be done by connecting the input of the operational amplifier 526 to the input of the coil L1 of the transformer 502. By this manner, in the capacitor charger 600, the servo voltage on the servo node 524 will follow the battery voltage V_{bat}.

When the transistor 512 conducts a current I1, the secondary coil voltage V_{S} of the transformer 502 is at a negative level, and the transistor 522 is thus turned off, and the feedback signal V_{FB} is equal to zero. When the transistor 512 is turned off, the current I2 charges the capacitor C_{O}, and the servo voltage on the servo node 524 is V_{bat}. By substituting the voltage V_{bat} into the equation EQ-9 for the voltage V_{B}, the feedback signal is

$${V}_{FB} = \frac{R1 \times ( Vout + {V}_{f} - Vbat )}{R2} . \qquad [ EQ \text{-} 10 ]$$

Likewise, when the feedback signal V_{FB} is equal to or larger than the reference Vref, the output S of the comparator 518 will signal the control circuit 514 to stop charging the capacitor C_{O}. Also, the diode 506 prevents the capacitor C_{O} from leakage through the resistors R1 and R2 and the transistor 522 to ground GND.

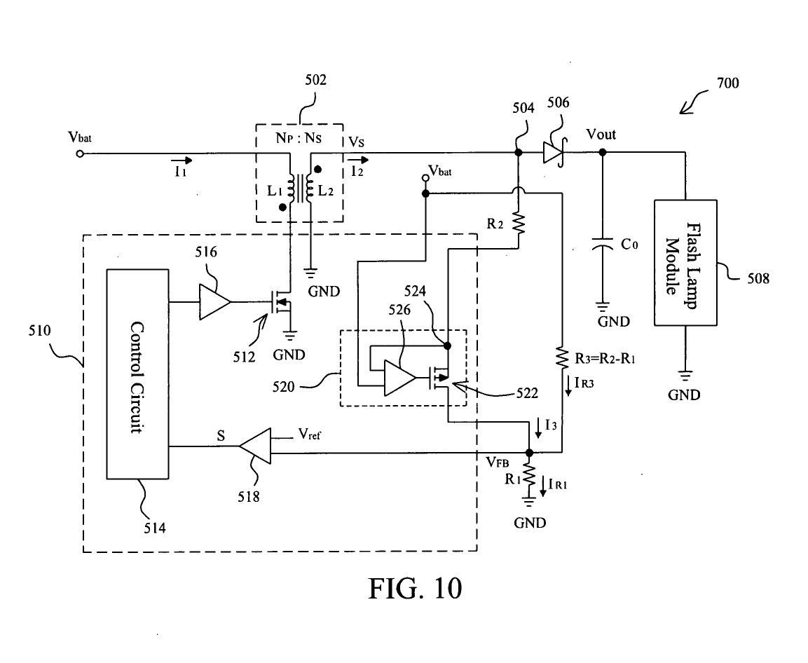

FIG. 10 shows the sixth embodiment of the present invention, which capacitor charger 700 is a further modification of the charger 600 shown in FIG. 9 with a resistor R3 connected between the reference voltage V_{bat} for the servo amplifier 520 and the feedback node V_{FB}, and the resistor R3 has a resistance
R3=R2−R1. [EQ-11]
Since the resistors R1 and R3 are connected in series between the voltage V_{bat} and ground GND, the current flowing through the resistor R3 is

$${I}_{R3} = \frac{{V}_{bat}}{R1 + R3} . \qquad [ EQ \text{-} 12 ]$$

Substituting the equation EQ-11 into the equation EQ-12, it has

$${I}_{R3} = \frac{{V}_{bat}}{R1 + R2 - R1} = \frac{{V}_{bat}}{R2} . \qquad [ EQ \text{-} 12 ]$$

When the transistor 512 conducts a current I1, the secondary coil voltage V_{S} of the transformer 502 is at a negative level, and the transistor 522 is thus turned off, and the feedback signal V_{FB} is equal to zero. When the transistor 512 is turned off, the current I2 charges the capacitor C_{O}, and the servo voltage on the servo node 524 is V_{bat}. In addition to the current I3, the current I_{R3} is also supplied to the resistor R1, and thus the total current flowing through the resistor R1 is
I_{R1}=I₃+I_{R3}. [EQ-14]
Substituting the voltage V_{bat} into the equation EQ-8 for the voltage V_{B}, it is obtained the sense current

$$I3 = \frac{Vout + {V}_{f} - {V}_{bat}}{R2} . \qquad [ EQ \text{-} 15 ]$$

According to the equations EQ-12, EQ-13, and EQ-14, the total current flowing through the resistor R1 becomes

$${I}_{R1} = \frac{Vout + {V}_{f} - {V}_{bat}}{R2} + \frac{{V}_{bat}}{R2} = \frac{Vout + {V}_{f}}{R2} , \qquad [ EQ \text{-} 16 ]$$

and therefore, the feedback signal is

$${V}_{FB} = \frac{R1 \times ( Vout + {V}_{f} )}{R2} . \qquad [ EQ \text{-} 17 ]$$

Likewise, when the feedback signal V_{FB} is equal to or larger than the reference Vref, the output S of the comparator 518 has the control circuit 514 to stop charging the capacitor C_{O}, and the diode 506 prevents the capacitor C_{O} from leakage through the resistors R1 and R2 and the transistor 522 to ground GND.

It is shown by the equation EQ-17, the introduction of the resistor R3 eliminates the effect from the primary coil voltage V_{bat} to the feedback signal V_{FB}. Battery is typically used for the power source (V_{bat}) of a capacitor charger, and the supplied voltage of the battery drops down gradually as the time goes by. This embodiment shown in FIG. 10 prevents the capacitor charger 700 from operating in error resulted from the decline or exhaustion of the battery power. In addition, this embodiment also shows the excellent operations adaptive to various battery voltage V_{bat}.

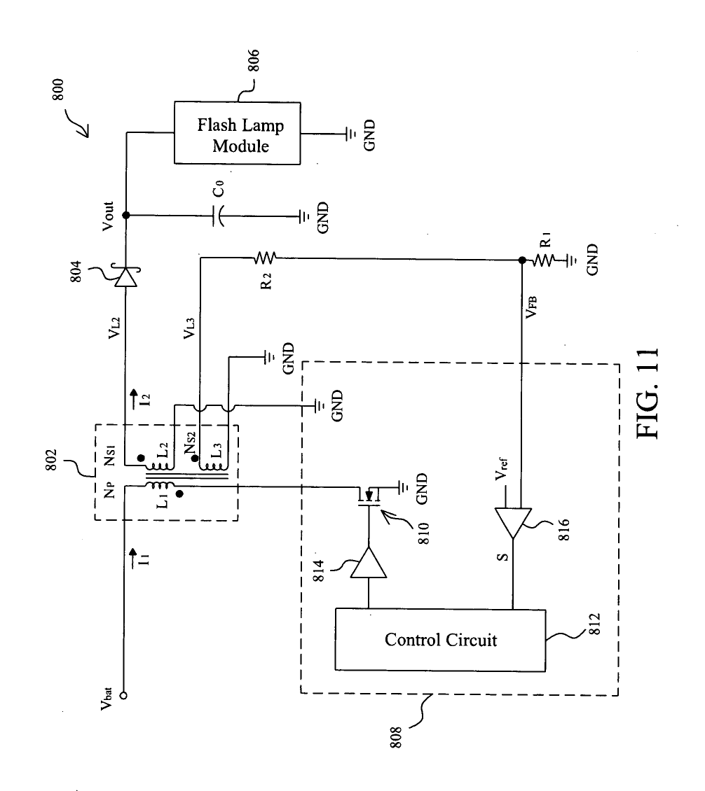

FIG. 11 shows the seventh embodiment of the present invention. In a capacitor charger 800, a transformer 802 has a primary coil L1 and a secondary coil L2 with a turns ratio of N_{P}:N_{S} to transform the primary coil voltage V_{bat} to a secondary coil voltage V_{L}2 to charge a capacitor C_{O} connected to an output Vout to supply a flash lamp module 806, an integrated circuit 808 switches a transistor 810 connected between the coil L1 and ground GND by a driver 814 through a control circuit 812 to control the power delivery of the transformer 802. To sense the capacitor voltage Vout, another secondary coil L3 is employed to transform the primary coil voltage V_{bat} to another secondary coil voltage V_{L}3, and resistors R1 and R2 are connected in series between the secondary coil voltage V_{L}3 and ground GND to divide the secondary coil voltage V_{L}3 to generate a feedback signal V_{FB} for the integrated circuit 808 that has a comparator 816 to compare the feedback signal V_{FB} with a reference Vref to determine a signal S for the control circuit 812 to stop charging the capacitor C_{O} when the capacitor voltage Vout reaches a predetermined value. A diode 804 is connected between the coil L2 and output Vout to prevent an inverse current flowing from the output Vout to the transformer 802.

When the transistor 810 conducts a current I1, the secondary coil voltage of the coil L3 is

$${V}_{L3} = ( - {V}_{bat} ) \times \frac{Ns2}{Np} , \qquad [ EQ \text{-} 18 ]$$

and therefore, according to voltage dividing theory, the feedback signal is

$${V}_{FB} = ( - {V}_{bat} ) \times \frac{Ns2}{Np} \times \frac{R1}{R1 + R2} , \qquad [ EQ \text{-} 19 ]$$

which is negative value. To prevent the integrated circuit 808 from latch-up, the turns ratio N_{P}:N_{S} of the coils L1 and L2 and the resistance ratio of the resistors R1 and R2 are selected to have the feedback signal V_{FB} not lower than −0.3V. On the other hand, when the transistor 810 is turned off, the capacitor C_{O} is charged by a current I2, and the feedback signal is

$${V}_{FB} = {V}_{L3} \times \frac{R1}{R1 + R2} , \qquad [ EQ \text{-} 20 ]$$

and due to the turns ratio N_{S}1:N_{S}2 between the coils L2 and L3, it is obtained

$${V}_{L3} = {V}_{L2} \times \frac{Ns2}{Ns1} . \qquad [ EQ \text{-} 21 ]$$

Substituting the equation EQ-21 into the equation EQ-20, the feedback signal becomes

$${V}_{FB} = {V}_{L2} \times \frac{Ns2}{Ns1} \times \frac{R1}{R1 + R2} . \qquad [ EQ \text{-} 22 ]$$

From this equation EQ-22, it is shown that the feedback signal V_{FB} is proportional to the secondary coil voltage V_{L}2 of the coil L2. Since the voltage sense apparatus to sense the voltage Vout on the capacitor C_{O} in this embodiment 800 is coupled to ground GND through the coil L3, there is no leakage consideration for the capacitor C_{O}.

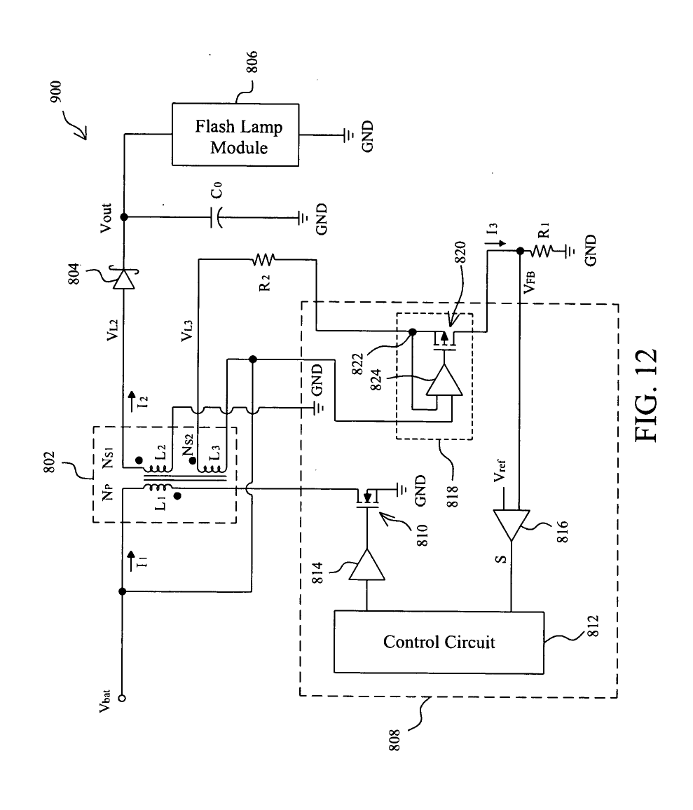

FIG. 12 shows the eighth embodiment of the present invention, which capacitor charger 900 is a modification of the charger 800 shown in FIG. 11 with one terminal of the secondary coil L3 connected to the input V_{bat} of the primary coil L1 and a servo amplifier 818 connected between the resistors R1 and R2. The servo amplifier 818 has an operational amplifier 824 with its two inputs connected to the primary coil voltage V_{bat} and a servo node 822, respectively, for the servo node 822 to be at the primary coil voltage V_{bat}, and a transistor 820 connected between the servo node 822 and a feedback node V_{FB} with its gate connected with the output of the operational amplifier 824. Since the servo voltage on the servo node 822 is V_{bat} and the secondary coil L3 is also connected to V_{bat}, the voltage drop across the resistor R2 is the secondary coil voltage VL3, by which a sense current I3 is generated to provide to the feedback node V_{FB} through the transistor 820, thereby generating the feedback signal V_{FB} by the transistor R1 for the integrated circuit 808 that has a comparator 816 to compare the feedback signal V_{FB} with a reference Vref to generate a comparison signal S for the control circuit 812 to stop charging the capacitor C_{O} when the capacitor voltage Vout reaches a predetermined value. Likewise, a diode 804 is connected between the coil L2 and output Vout to prevent an inverse current flowing from the output Vout to the transformer 802.

When the transistor 810 conducts a current I1, the voltage V_{L}3 has a negative value, and the transistor 820 is therefore turned off, and the feedback signal V_{FB} is equal to zero. When the transistor 810 is turned off, the capacitor C_{O} is charged by a current I2, and the charging voltage is
V_{L}2=Vout+V_{f}, [EQ-23]
where V_{f} is the forward bias of the diode 804. Due to the turns ratio of the coils L2 and L3 is N_{S}1:N_{S}2, it has

$${V}_{L} 3 = {V}_{L2} \times \frac{Ns2}{Ns1} + {V}_{bat} . \qquad [ EQ \text{-} 24 ]$$

Since the servo voltage on the servo node 822 is maintained at V_{bat} by the servo amplifier 818, the sense current flowing through the resistor R2 is

$$I3 = \frac{{V}_{L3}}{R2} , \qquad [ EQ \text{-} 25 ]$$

and the feedback signal will be

$${V}_{FB} = I3 \times R1 = \frac{R1}{R2} {V}_{L3} . \qquad [ EQ \text{-} 26 ]$$

Combined with the equation EQ-24, it is obtained

$${V}_{FB} = \frac{R1}{R2} \times ( {V}_{L2} \times \frac{Ns2}{Ns1} + {V}_{bat} ) \qquad [ EQ \text{-} 27 ]$$

From the equation EQ-27, it is shown that the feedback signal V_{FB} is proportional to the secondary coil voltage V_{L}2. Likewise, there is no leakage consideration resulted from the voltage sense apparatus for the capacitor C_{O} since the voltage sense apparatus is coupled to the coil L3 to sense the capacitor voltage Vout.

Briefly, the leakage from the charged capacitor through the voltage sense apparatus is prevented either by a rectifier circuit such as a diode inserted between the capacitor and voltage sense apparatus, or by a second secondary coil to remove the voltage sense apparatus from direct connection to the first secondary coil to charge the capacitor. The effect to the operation resulted from the power exhaustion of battery is further eliminated.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. In a capacitor charger including a transformer to transform a primary coil voltage to a secondary coil voltage to charge through a charging node a capacitor that is connected to an output to approach a predetermined voltage thereon, a voltage sense apparatus for generating a feedback signal for the capacitor charger when the capacitor voltage is sensed to be equal to or higher than the predetermined voltage to thereby stop charging the capacitor, the voltage sense apparatus comprising:
a voltage divider connected between the charging node and a reference voltage and having a feedback arrangement for generating the feedback signal; and
a rectifier circuit connected between the charging node and output for preventing an inverse current flowing from the capacitor to the charging node.

2. The voltage sense apparatus of claim 1, wherein the voltage divider comprises a resistor with a voltage drop thereon for generating the feedback signal.

3. The voltage sense apparatus of claim 1, wherein the voltage divider comprises a second rectifier circuit for preventing an inverse current flowing from the voltage divider to the charging node.

4. The voltage sense apparatus of claim 3, wherein the second rectifier circuit comprises a diode.

5. The voltage sense apparatus of claim 1, further comprising a voltage clamping circuit connected to the voltage divider for clamping the feedback signal not lower than a threshold.

6. The voltage sense apparatus of claim 5, wherein the voltage clamping circuit comprises:
a resistor connected between the feedback arrangement and a clamping node; and
one or more diodes connected between the clamping node and a second reference voltage.

7. The voltage sense apparatus of claim 1, wherein the rectifier circuit comprises a diode.

8. The voltage sense apparatus of claim 1, wherein the voltage divider comprises:
a first resistor connected between the charging node and a clamping node;
one or more second resistors connected in series between the clamping node and reference voltage; and
one or more diodes connected in series between the clamping node and a second reference voltage.

9. In a capacitor charger including a transformer to transform a primary coil voltage to a secondary coil voltage to charge through a charging node a capacitor that is connected to an output to approach a predetermined voltage thereon, a voltage sense apparatus for generating a feedback signal through a feedback node to the capacitor charger when the capacitor voltage is sensed to be equal to or higher than the predetermined voltage to thereby stop charging the capacitor, the voltage sense apparatus comprising:
a current source connected between the charging node and feedback node for providing a sense current;
a feedback arrangement connected between the feedback node and a reference voltage for generating the feedback signal from the sense current; and
a rectifier circuit connected between the charging node and output for preventing an inverse current flowing from the capacitor to the charging node.

10. The voltage sense apparatus of claim 9, wherein the current source comprises:
a resistor connected between the charging node and a servo node; and
a servo amplifier connected between the servo node and feedback node for the servo node to have a servo voltage thereon to thereby determine the sense current.

11. The voltage sense apparatus of claim 10, wherein the servo amplifier comprises:
a transistor connected between the servo node and feedback node for conducting the sense current therethrough; and
an operational amplifier having a pair of inputs connected with a second reference voltage and the servo node, respectively, for the servo node to have the second reference voltage thereon, and an output connected to a gate of the transistor.

12. The voltage sense apparatus of claim 10, wherein the servo voltage has a value proportional to the primary coil voltage.

13. The voltage sense apparatus of claim 12, further comprising a second resistor connected between the second reference voltage and feedback node.

14. The voltage sense apparatus of claim 9, wherein the feedback arrangement comprises a resistor.

15. The voltage sense apparatus of claim 9, wherein the rectifier circuit comprises a diode.

16. In a capacitor charger including a transformer to transform a primary coil voltage to a secondary coil voltage to charge through a charging node a capacitor that is connected to an output to approach a predetermined voltage thereon, a voltage sense apparatus for generating a feedback signal through a feedback node to the capacitor charger when the capacitor voltage is sensed to be equal to or higher than the predetermined voltage to thereby stop charging the capacitor, the voltage sense apparatus comprising:
a second secondary coil voltage transformed from the primary coil voltage;
a resistor connected to a servo node for being applied with the second secondary coil voltage thereacross to thereby generate a sense current;
a servo amplifier connected between the servo node and feedback node for the servo node to have a servo voltage thereon;
a feedback arrangement connected between the feedback node and a reference voltage for generating the feedback signal from the sense current; and
a rectifier circuit connected between the charging node and output for preventing an inverse current flowing from the capacitor to the charging node.

17. The voltage sense apparatus of claim 16, wherein the servo amplifier comprises:
a transistor connected between the servo node and feedback node for conducting the sense current therethrough; and
an operational amplifier having a pair of inputs connected with a second reference voltage and the servo node, respectively, for the servo node to have the second reference voltage thereon, and an output connected to a gate of the transistor.

18. The voltage sense apparatus of claim 16, wherein the feedback arrangement comprises a resistor.

19. The voltage sense apparatus of claim 16, wherein the rectifier circuit comprises a diode.

20. In a capacitor charger including a transformer to transform a primary coil voltage to a secondary coil voltage to charge through a charging node a capacitor that is connected to an output to approach a predetermined voltage thereon, a voltage sense apparatus for generating a feedback signal through a feedback node to the capacitor charger when the capacitor voltage is sensed to be equal to or higher than the predetermined voltage to thereby stop charging the capacitor, the voltage sense apparatus comprising:
a second secondary coil voltage transformed from the primary coil voltage;
a voltage divider connected between the second secondary coil voltage and a reference voltage and having a feedback arrangement for generating the feedback signal; and
a rectifier circuit connected between the charging node and output for preventing an inverse current flowing from the capacitor to the charging node.

21. The voltage sense apparatus of claim 20, wherein the voltage divider comprises a resistor with a voltage drop thereacross for generating the feedback signal.

22. The voltage sense apparatus of claim 20, wherein the rectifier circuit comprises a diode.

23. In a capacitor charger including a transformer to transform a primary coil voltage to a secondary coil voltage to charge through a charging node a capacitor that is connected to an output to approach a predetermined voltage thereon, a voltage sense method for generating a feedback signal for the capacitor charger when the capacitor voltage is sensed to be equal to or higher than the predetermined voltage to thereby stop charging the capacitor, the voltage sense method comprising the steps of:
preventing an inverse current flowing from the capacitor to the charging node;
sensing a charging voltage on the charging node; and
generating the feedback signal from the charging voltage.

24. The voltage sense method of claim 23, wherein the step of sensing a charging voltage on the charging node comprises connecting a resistor string between the charging node and a reference voltage.

25. The voltage sense method of claim 24, further comprising preventing an inverse current flowing from the resistor string to the charging node.

26. The voltage sense method of claim 24, further comprising the steps of:
selecting a servo node from a plurality of nodes in the resistor string; and
generating a servo voltage on the servo node.

27. The voltage sense method of claim 26, further comprising regulating the servo voltage proportional to the primary coil voltage.

28. The voltage sense method of claim 23, further comprising clamping the feedback signal not lower than a threshold.

29. The voltage sense method of claim 23, wherein the step of generating the feedback signal from the charging voltage comprises generating a sense current flowing through a resistor to thereby generate the feedback signal.

30. In a capacitor charger including a transformer to transform a primary coil voltage to a secondary coil voltage to charge through a charging node a capacitor that is connected to an output to approach a predetermined voltage thereon, a voltage sense method for generating a feedback signal for the capacitor charger when the capacitor voltage is sensed to be equal to or higher than the predetermined voltage to thereby stop charging the capacitor, the voltage sense method comprising the steps of:
preventing an inverse current flowing from the capacitor to the charging node;
generating a sense current from a voltage difference between a charging voltage on the charging node and a selected voltage; and
generating the feedback signal from a voltage drop derived from the sense current flowing through a resistor.

31. The voltage sense method of claim 33, further comprising regulating the selected voltage proportional to the primary coil voltage.

32. In a capacitor charger including a transformer to transform a primary coil voltage to a secondary coil voltage to charge through a charging node a capacitor that is connected to an output to approach a predetermined voltage thereon, a voltage sense method for generating a feedback signal for the capacitor charger when the capacitor voltage is sensed to be equal to or higher than the predetermined voltage to thereby stop charging the capacitor, the voltage sense method comprising the steps of:
preventing an inverse current flowing from the capacitor to the charging node;
transforming the primary coil voltage to a second secondary coil voltage;
sensing the second secondary coil voltage; and
generating the feedback signal from the sensed voltage.

33. The voltage sense method of claim 32, wherein the step of sensing the second secondary coil voltage comprises connecting a resistor string with the second secondary coil voltage thereacross.

34. The voltage sense method of claim 33, further comprising the steps of:
selecting a servo node from a plurality of nodes in the resistor string; and
generating a servo voltage on the servo node.

35. The voltage sense method of claim 34, further comprising regulating the servo voltage proportional to the primary coil voltage.

36. The voltage sense method of claim 32, wherein the step of generating the feedback signal from the sensed voltage comprises generating a sense current from the sensed voltage to flow through a resistor to thereby generate the feedback signal.

37. In a capacitor charger including a transformer to transform a primary coil voltage to a secondary coil voltage to charge through a charging node a capacitor that is connected to an output to approach a predetermined voltage thereon, a voltage sense method for generating a feedback signal for the capacitor charger when the capacitor voltage is sensed to be equal to or higher than the predetermined voltage to thereby stop charging the capacitor, the voltage sense method comprising the steps of:
preventing an inverse current flowing from the capacitor to the charging node;
transforming the primary coil voltage to a second secondary coil voltage;
generating a sense current from the second secondary coil voltage; and
generating the feedback signal by conducting the sense current flowing through a resistor.

38. The voltage sense method of claim 37, wherein the step of generating a sense current from the second secondary coil voltage comprises connecting a second resistor with the second secondary coil voltage thereacross.
